(19) United States
(12) Patent Application Publication
(10) Pub. No.: US 2008/0077617 A1
(43) Pub. Date: Mar. 27, 2008

(54) UNIVERSAL, HIERARCHICAL LAYOUT OF ASSETS IN A FACILITY

(75) Inventors: Glenn B. Schulz, Lannon, WI (US); Ardaman Singh Grewal, Milwaukee, WI (US)

Correspondence Address: ROCKWELL AUTOMATION, INC./(AT), ATTENTION: SUSAN M. DONAHUE, E-7F19, 1201 SOUTH SECOND STREET, MILWAUKEE, WI, 53204, US

(73) Assignee: ROCKWELL AUTOMATION TECHNOLOGIES, INC., Mayfield Heights, OH (US)

(21) Appl. No.: 11/535,672

(22) Filed: Sep. 27, 2006

(51) Int. Cl. G06F 17/00

(52) U.S. Cl. 707/104.1

(57) ABSTRACT

The claimed subject matter provides a system and/or method that facilitates asset management within an industrial environment. A data repository can retain a hierarchical representation of at least one asset persisted within a computer-readable medium. A receiver component can receive an input related to a selection of at least one asset and a respective asset management functionality. A management component can automatically effectuate the requested asset management functionality with respect to the asset within the industrial environment.

### TECHNICAL FIELD

The claimed subject matter relates generally to asset management in a facility and, more particularly, to representing assets within an industrial facility.

### BACKGROUND

Due to advances in computing technology, businesses today are able to operate more efficiently when compared to substantially similar businesses only a few years ago. For example, internal networking enables employees of a company to communicate instantaneously by email, quickly transfer data files to disparate employees, manipulate data files, share data relevant to a project to reduce duplications in work product, etc. Furthermore, advancements in technology have enabled factory applications to become partially or completely automated. For instance, operations that once required workers to put themselves proximate to heavy machinery and other various hazardous conditions can now be completed at a safe distance therefrom.

Further, imperfections associated with human action have been minimized through employment of highly precise machines. Many of these factory devices supply data related to manufacturing to databases or web services referencing databases that are accessible by system/process/project managers on a factory floor. For instance, sensors and associated software can detect a number of instances that a particular machine has completed an operation given a defined amount of time. Additionally, data from sensors can be delivered to a processing unit related to system alarms. Thus, a factory automation system can review collected data and automatically and/or semi-automatically schedule maintenance of a device, replacement of a device, and other various procedures that relate to automating a process.

Control of a process is typically effectuated through controlling one or more assets within a facility, wherein assets can include hardware, such as programmable logic controllers, machines, switches, and the like as well as software components, such as certain programs, sub-programs, and the like. The assets themselves are typically associated with an asset management program or functionality, which is conventionally is associated with tasks such as backing up devices, checking auditing capabilities, archiving data, periodic scanning of assets to ensure that they are operating without problems, monitoring data entering and leaving a plant floor, and the like. To initiate functionality associated with asset management, one conventionally selects a desired functionality and thereafter assets are displayed that are associated with such functionality. Pursuant to one particular example, to back up a PLC, a user begins such backup by initiating an application function. Thereafter, a schedule is created and functionality associated with backing up the PLC is placed within the schedule. Finally, the schedule is run and the PLC is backed up. There is no convenient mechanism for initially determining what functionality is associated with an asset much less conveniently managing particular assets.

### SUMMARY

The following presents a simplified summary of the claimed subject matter in order to provide a basic understanding of some aspects described herein. This summary is not an extensive overview, and is not intended to identify key/critical elements or to delineate the scope of the claimed subject matter. Its sole purpose is to present some concepts in a simplified form as a prelude to the more detailed description that is presented later.

The subject innovation relates to systems and/or methods that facilitate managing one or more assets within an industrial environment. A management component can receive a data input via a receiver component to automatically employ asset management functionality for a particular asset within the industrial automation environment. A user can select the representation of the asset through the receiver component, which can be or include a pointing and clicking mechanism, a pressure-sensitive screen, voice commands, software associated with selecting the representation of the asset, or any other suitable manner for selecting an asset. Once the representation of the asset isn selected, asset management functionality that is available with respect to the selected asset can be provided to the user. The user can then select such functionality, and the management component can effectuate the requested functionality with respect to the asset within the industrial environment. For instance, management can relate to validating an asset, backing up an asset, archiving data associated with an asset, updating an asset with new or additional software or firmware, and the like. The asset can be a physical device, such as a programmable logic controller, a pump, a press, a valve, a drain, a heater, a cooler, a switch, a sensor, a conveyor, and/or a portion thereof, as well as software, firmware, etc. The industrial environment can include various assets that can be verified and/or quality ensured, wherein at least two assets can be hierarchically arranged, such as one that is utilized to manufacture consumables, textiles, automobiles, or any other suitable industrial environment.

The subject innovation can further include a data repository that can retain the hierarchical representation of assets, wherein the hierarchical arrangement can be provided to a user by way of the graphical user interface component. The data repository can be a single data repository and/or can be a distributed data store. The hierarchy can be based at least in part upon the physical location of devices (e.g., a region of a factory can have several defined sub-regions, which in turn can comprise sub-regions), standards associated with industry, such as ISA, S95, ISA S88, and the like, proprietary hierarchy that is provided by an enterprise, or any other suitable hierarchy.

In accordance with another aspect of the innovation described herein, the system can utilize a detection component that can detect any alterations associated with assets within the industrial environment. In particular, the detection component can be communicatively coupled to the industrial environment and poll the assets to ascertain if any assets have been added, removed, changed, and/or any combination thereof. Moreover, the subject innovation can further include an updating component that can update the hierarchical representation of assets in accordance with any alterations detected by the detection component. By providing detection and updating of any alterations associated with the assets within the industrial environment, the management component can provide accurate and up-to-date information to a user and/or entity. In other aspects of the claimed subject matter, methods are provided that facilitate managing one or more assets within an industrial environment.

To the accomplishment of the foregoing and related ends, certain illustrative aspects of the claimed subject matter are described herein in connection with the following description and the annexed drawings. These aspects are indicative, however, of but a few of the various ways in which the principles of the claimed subject matter can be employed and such subject matter is intended to include all such aspects and their equivalents. Other advantages and novel features will become apparent from the following detailed description of the invention when considered in conjunction with the drawings.

### BRIEF DESCRIPTION OF THE DRAWINGS

FIG. 1 illustrates a system that facilitates managing one or more assets within an industrial environment.

FIG. 2 illustrates a block diagram of an exemplary system that facilitates updating the hierarchical representation of assets with respect to assets that are added, updated, or removed from the industrial environment.

FIG. 3 illustrates a block diagram of an exemplary system that facilitates automatically creating a hierarchical representation of assets.

FIG. 4 illustrates a block diagram of an exemplary system that facilitates updating contents of the hierarchical representation of assets.

FIG. 5 illustrates a block diagram of an exemplary system that facilitates automatically providing asset management in accordance with the claimed subject matter.

FIG. 6 illustrates a block diagram of an exemplary system that facilitates managing one or more assets within an industrial environment.

FIG. 7 illustrates a block diagram of an exemplary system that facilitates providing security mechanisms in connection with managing one or more assets within an industrial environment.

FIG. 8 illustrates an exemplary methodology for managing one or more assets within an industrial environment.

FIG. 9 illustrates an exemplary methodology that facilitates automatically updating the hierarchical representation of assets with respect to assets that are added, updated, or removed from the industrial environment.

FIG. 10 illustrates an exemplary methodology for automatically creating a hierarchical representation of assets.

FIG. 11 illustrates a block diagram of an exemplary data structure that represents a hierarchical structure of an industrial automation system.

FIG. 12 is an exemplary networking environment that can be utilized in connection with the claimed subject matter.

FIG. 13 is an exemplary computing environment that can be utilized in connection with the claimed subject matter.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that such matter can be practiced without these specific details. In other instances, well-known structures and devices are shown in block diagram form in order to facilitate describing the invention.

As used in this application, the terms “component” and “system” are intended to refer to a computer-related entity, either hardware, a combination of hardware and software, software, or software in execution. For example, a component may be, but is not limited to a process running on a processor, a processor, an object, an executable, a thread of execution, a program, and a computer. By way of illustration, both an application running on a server and the server can be a component. One or more components may reside within a process and/or thread of execution and a component may be localized on one computer and/or distributed between two or more computers. The word “exemplary” is used herein to mean serving as an example, instance, or illustration. Any aspect or design described herein as “exemplary” is not necessarily to be construed as preferred or advantageous over other aspects or designs.

Furthermore, aspects of the claimed subject matter may be implemented as a method, apparatus, or article of manufacture using standard programming and/or engineering techniques to produce software, firmware, hardware, or any combination thereof to control a computer to implement various aspects of the subject invention. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., card, stick, key drive, etc.). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of what is described herein.

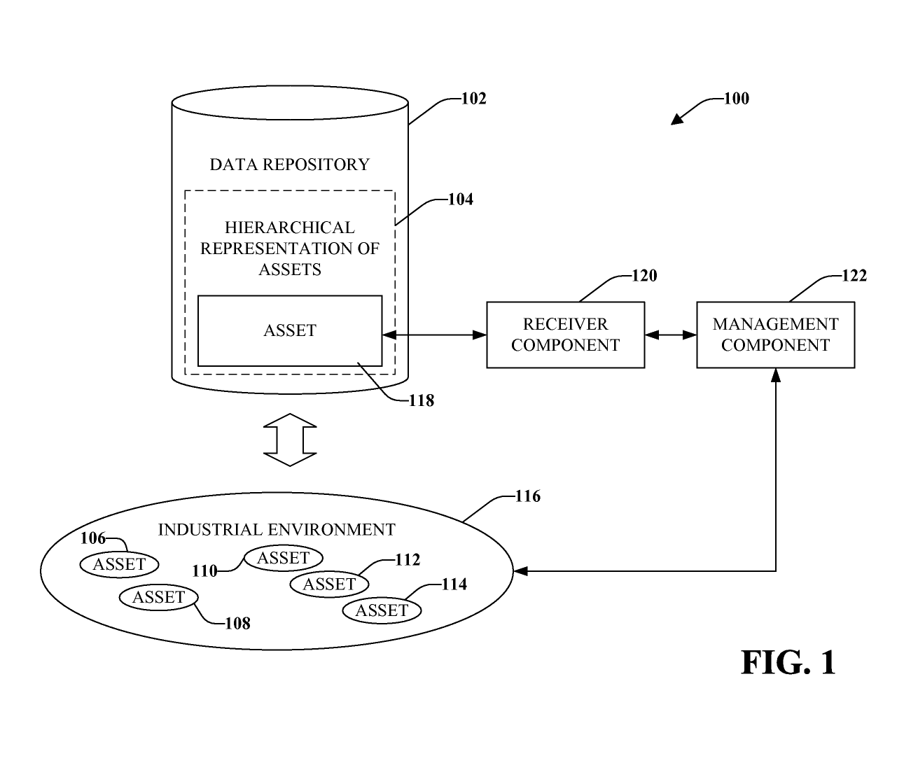

Now referring to the drawings, FIG. 1 illustrates a system 100 that facilitates managing one or more assets within an industrial environment. For instance, management can relate to validating an asset, backing up an asset, archiving data associated with an asset, updating an asset with new or additional software or firmware, and the like. Further, an asset can be a physical device, such as a programmable logic controller, a pump, a press, and/or a portion thereof, as well as software, firmware, etc. Conventionally, to perform management upon one or more assets within an industrial environment, a desired functionality is selected through an asset management application, a desired asset is located, such asset is checked out and placed within a schedule, the schedule is run, and then the asset is checked back in. Such process is counterintuitive and results in inefficiencies and mistakes in connection with managing multiple assets.

The system 100 overcomes such deficiencies by incorporating an asset-centric approach rather than a functionality-centric approach to asset management. The system 100 can include a data repository 102 that can retain a hierarchical representation of assets 104, wherein the hierarchical arrangement can be provided to a user by way of a graphical user interface (not shown). The data repository 102 can be a single data repository and/or can be a distributed data store. The hierarchy can be based upon location of devices (e.g., a region of a factory can have several defined sub-regions, which in turn can comprise sub-regions), standards associated with industry, such as ISA S95, ISA S88, and the like, a proprietary hierarchy that is provided by an enterprise, or any other suitable hierarchy. For instance, a top portion of the hierarchy may be a plant, and a sub-level of the plant may be programmable logic controllers utilized within the plant, and a sub-level of the programmable logic controllers can be devices controlled by such controllers. It is understood that this is but one example of a hierarchy, and is for illustrative purposes only.

The hierarchically representation of assets 104 can represent a hierarchically arrangement of two or more assets 106-114 within an industrial environment 116, such as one that is utilized to manufacture consumables, textiles, automobiles, or any other suitable industrial environment. To illustrate another example hierarchy, the asset 110 may be a programmable logic controller, while the assets 112 and 114 may be different control programs effectuated by the asset 110. Thus, the hierarchical representation of assets 104 may be a combination of physical devices and software.

The hierarchical representation of assets 104 can include a representation of an asset 118 that is requested by a user. For instance, the user may wish to perform particular management functionality with respect to the asset. The user can select the representation of the asset 118 through a receiver component 120, which can be or include a pointing and clicking mechanism, a pressure-sensitive screen, voice commands, software associated with selecting the representation of the asset 118, or any other suitable manner for selecting an asset. Once the representation of the asset 118 has been selected, asset management functionality that is available with respect to the selected asset can be provided to the user. The user can then select such functionality, and a management component 122 can effectuate the requested functionality with respect to the asset within the industrial environment 116. Thus, for instance, if the representation of the asset 118 represents a PLC, and the user selects such representation 118, functionality such as “back up PLC”, “archive data within the PLC”, “update PLC with particular firmware”, and the like can be provided to the user. Once the user selects desired functionality, the management component 122 can automatically perform the requested function. For instance, the PLC can be backed up by the management component 122 if the user selects the “backup PLC” functionality. Accordingly, the system 100 is more intuitive when compared to conventional systems, as effectuation of management functionality is asset-centric. Additionally, locating an asset and functionality associated therewith is made easier through the hierarchical representation of assets.

The management component 122 can additionally cause a selected asset management functionality to permeate through lower levels of the hierarchy. For example, the hierarchy can be based upon location, and various devices and software can reside in the hierarchy beneath the location. If the user selects a certain area and thereafter selects a “validate” functionality, the functionality can be permeated through each of the devices within that area. One skilled in the art will appreciate that various asset management functionalities can be permeated throughout any suitable portions of a hierarchy.

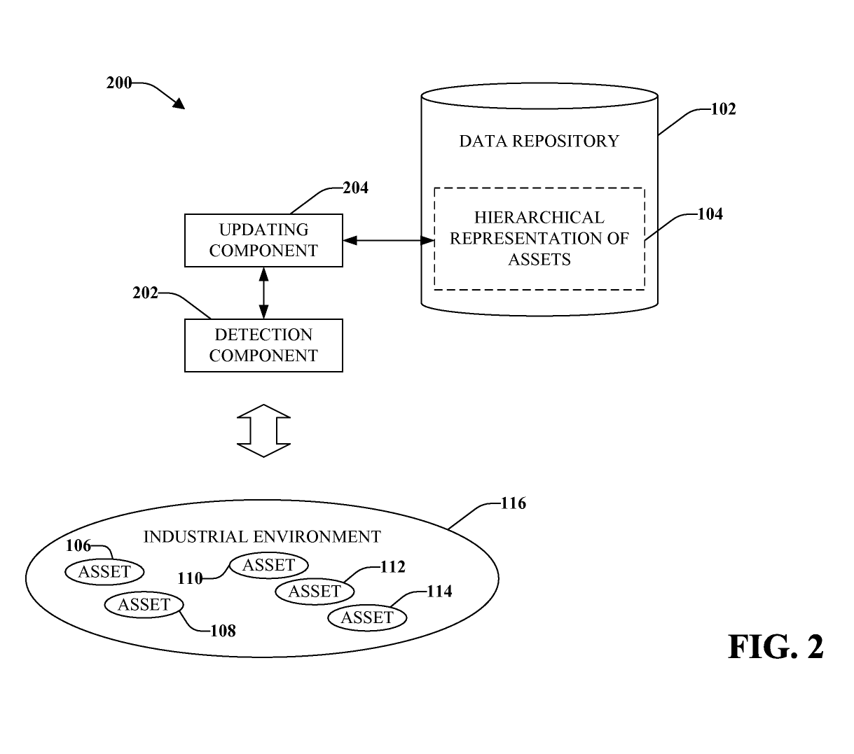

Turning now to FIG. 2, a system 200 that facilitates updating the hierarchical representation of assets 104 with respect to assets that are added, updated, or removed from the industrial environment 116 is illustrated. The system 200 includes a detection component 202 that is communicatively coupled to the assets 106-114 within the industrial environment 116. For instance, the assets 106-114 can be communicatively coupled by way of an intranet or other suitable network. The detection component 202 can determine when an asset has been added to the industrial environment 116, removed from the industrial environment 116, or updated within the industrial environment 116. Pursuant to one example, the detection component 202 can poll a network to determine whether any alterations have been made with respect to assets resident upon the network. In another example, an asset may have sufficient intelligence to initiate a message to the detection component 202, wherein such message can include a type or identity of the asset, location upon a network of the asset, associated assets, etc. Still further, an asset can indicate to the detection component 202 a type of update associated with the asset.

Once an alteration occurs with respect to one or more assets within the industrial environment 116 and such alteration has been detected by the detection component 202, an updating component 204 can update the hierarchical representation of assets 104 within the data repository 102. For instance, if an asset is added to the industrial environment 116, the updating component 204 can determine a type of such asset, location of the asset, and the like based upon detections made by the detection component 202. The updating component 204 can then review the structure of the hierarchical representation of assets 104 (e.g., to determine whether it is based on location, functionality of devices, . . . ). Once this review has been undertaken, the updating component 204 can intelligently and automatically update the hierarchical representation of assets 104. For instance, if an asset is added to the industrial environment 116, the updating component 204 can add the asset in an appropriate position within the hierarchical representation of assets 104. Additionally, the updating component 204 can associate the asset with a particular graphical icon that is typically associated with assets that are of the same type as the newly added asset.

The updating component 204 can also be employed to associate updated functionality with assets represented within the hierarchical representation of assets. Pursuant to an example, particular verification functionality may become available with respect to certain PLCs. The updating component can update the functionality with respect to such PLCs that are represented within the hierarchical representation of assets 104. Therefore, if a representation of such asset is selected by a user, the new or enhanced functionality will also be displayed. According to an example, the updating component 204 can be connected to a network (e.g., the Internet) and can receive functionality updates through web services or the like.

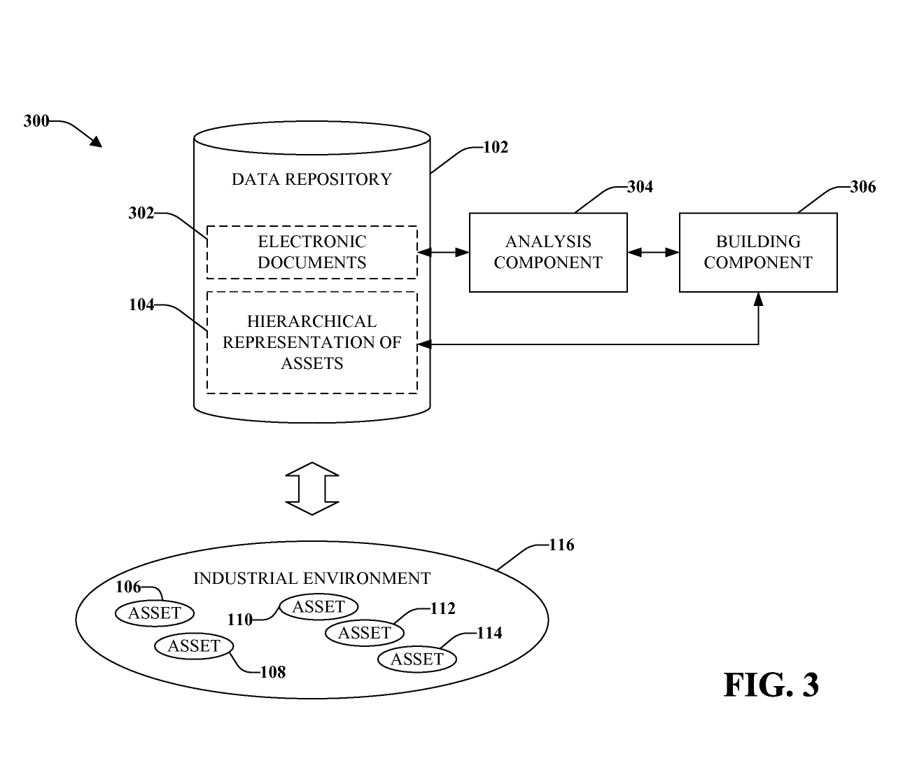

Referring now to FIG. 3, a system 300 for automatically creating the hierarchical representation of assets 104 is illustrated. The system 300 includes the data repository 102 that retains the hierarchical representation of assets 104. The data repository 102 can additionally include electronic documents 302 that are associated with assets that are employed and/or are possibly employed within the industrial environment 116. The electronic documents 302 may be descriptive of operation of assets, such as operation instructions. The electronic documents 302 can also be warranties or any other suitable documents relating to assets within the industrial environment 116. While shown as residing within the same data repository 102, it is understood and appreciated that the electronic documents 302 and the hierarchical representation of assets can reside upon different storage mediums and/or can be distributed across several storage mediums.

The system 300 further includes an analysis component 304 that analyzes content of the electronic documents to determine type of assets and relationships between assets. Furthermore, the analysis component 304 can analyze metadata associated with the electronic documents 302, such as to determine time of purchase of an asset, identity of an individual who effectuated the purchase, etc. Results of the analysis can be passed to a building component 306, which can then build the hierarchical representation of assets 104. If an individual responsible for creating the hierarchical representation of assets 104 reviews such representation 104 and determines that changes are to be made (after the building component 306 builds such representation 104), the individual can manually undertake the alterations.

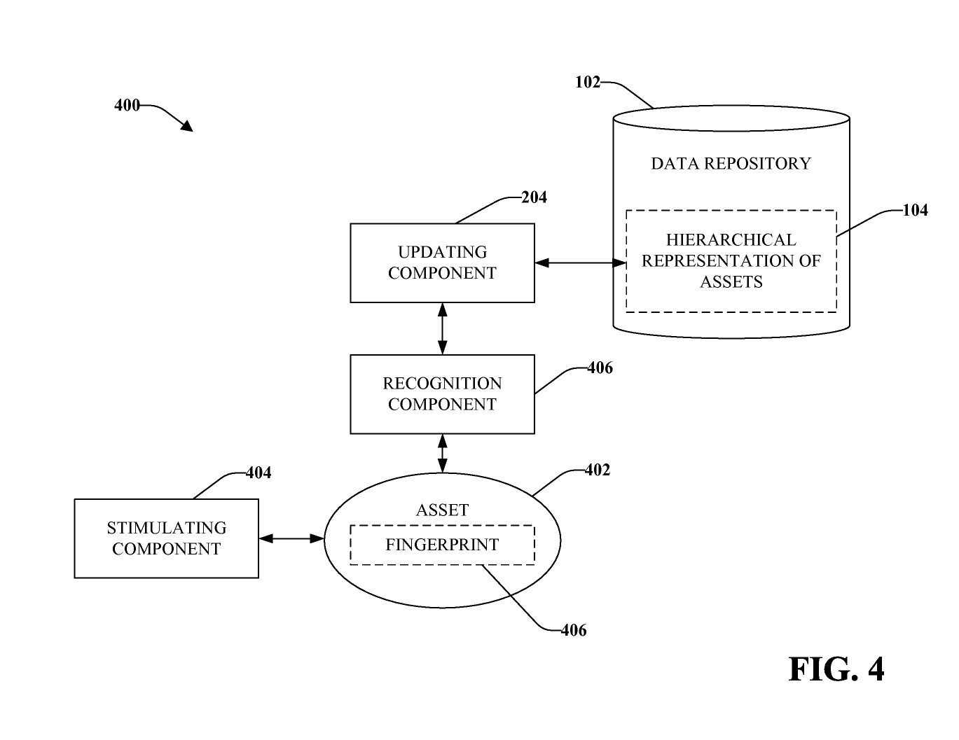

Referring now to FIG. 4, a system 400 that facilitates updating contents of the hierarchical representation of assets 104 is illustrated. The system 400 includes the data repository 102, which includes the hierarchical representation of assets 104. The data repository 102 can be a computer-readable medium, such as a hard disk, memory, and/or a combination thereof. The system 400 depicts an instance that an asset 402 does not include sufficient intelligence to inform the updating component 204 of its identity when such asset 402 is coupled to a network. It may be known, however, how particular assets react to certain stimulation. Accordingly, when the asset 402 is added to a network, a stimulating component 404 can provide the asset with certain electrical stimuli. The asset 402 is associated with a fingerprint 406 that can be utilized to identify the asset 402, wherein the fingerprint 406 makes itself known when provided with particular stimuli. Pursuant to one example, the stimulating component 404 can be an electrical power source which provides certain electrical pulses to the asset 402 to determine the fingerprint 406. For instance, the asset 402 can react in a certain manner to particular stimuli, thus illuminating the fingerprint 406 to a recognition component 408.

The recognition component 408 can be trained to monitor responses of the asset 402 with respect to certain stimuli provided by the stimulating component 404. Thus, the recognition component 408 can determine an identity of the asset (and possibly relationships to other assets) by discerning the fingerprint 406 associated with such asset 402. The updating component 204 can thereafter utilize this information as well as other available information to update the hierarchical representation of assets 104. Thus, a representation of the asset 402 can be placed appropriately within the hierarchical representation of assets 104 by the updating component 204. Asset management functionality associated with the asset can also be discerned based at least in part upon the fingerprint 406 (e.g., whether device backup is available, data archiving is available, . . . ).

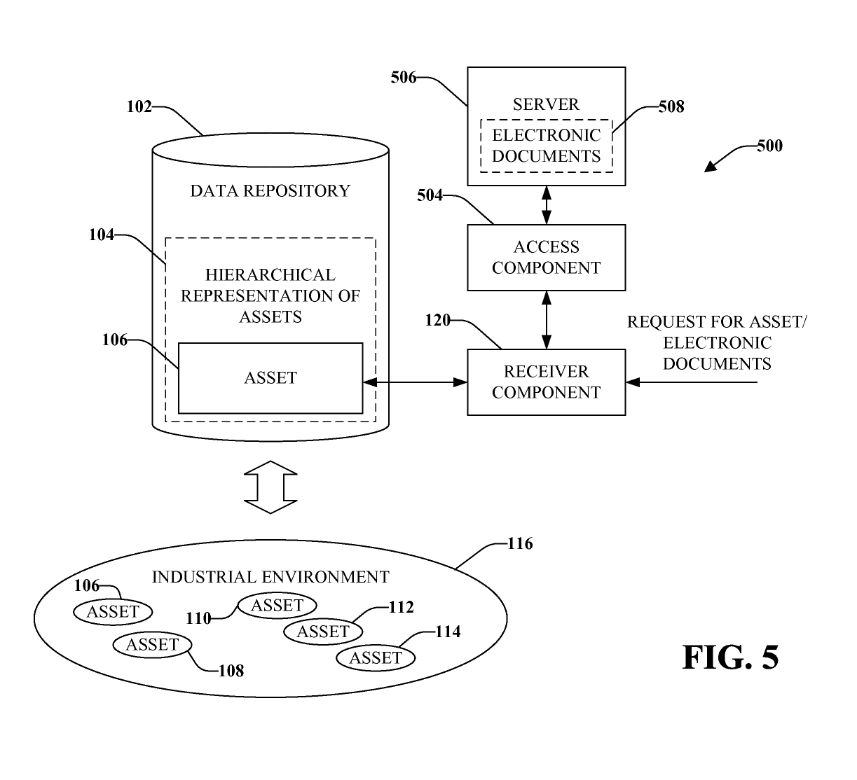

Turning now to FIG. 5, an asset management system 500 is illustrated. The system 500 includes the data repository 102 that retains the hierarchical representation of assets 104, which represent the logical and/or geographic arrangement of the plurality of assets 106-114 within the industrial environment 116. The system 500 additionally includes the receiver component 120, which receives a request for an asset and electronic documents associated with such asset. For instance, a user can utilize a mouse to select a representation 502 of the aforementioned asset within a graphical display of the hierarchical representation of assets 104. Once selected, options relating to reviewing or updating one or more electronic documents can be provided to the user. Furthermore, the user can be made aware of types of electronic documents available with respect to a desired asset (e.g., warranty documents, schematics, user manuals, . . . ). The user can select a desired electronic document through use of the receiver component 120.

Once an electronic document or documents is selected, an access component 504 can be initiated, which accesses a server 506 that retains a plurality of electronic documents 508. The access component 504 can retrieve an appropriate electronic document and provide such document to, for instance, a client device that is being employed by the user. It may be desirable, however, to prohibit transmittal of one or more of the electronic documents 508—therefore, a virtual private network (VPN) can be utilized to enable review of electronic documents on the server 506 but prevent replication and/or transmittal of such documents. Additionally or alternatively, time limitations can be associated with certain electronic documents, such that a user can review a certain document for a limited amount of time prior restricting access to such document.

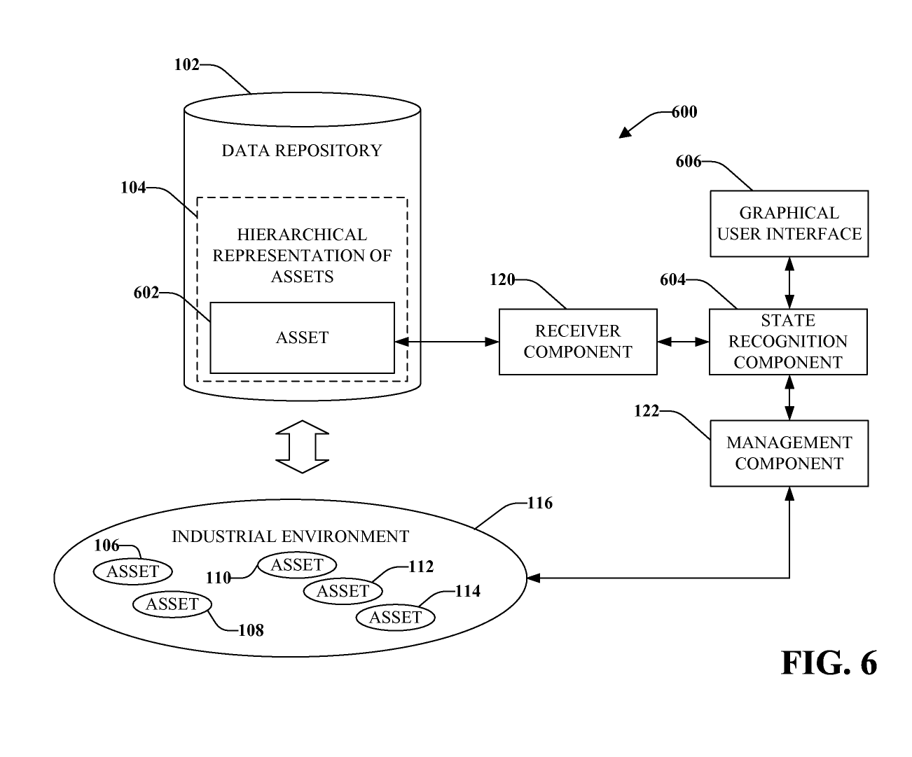

Now referring to FIG. 6, an asset management system 600 for utilization in connection with an industrial environment is illustrated. The system 600 includes the receiver component 120 that receives a request with respect to a representation of an asset 602 within the industrial environment 116. For example, a user may wish to perform a backup with respect to a particular asset within the industrial environment 116. Prior to enabling such functionality, however, a state recognition component 604 can be employed to discern states of assets within the industrial environment 116. For example, certain functionality may not be available given certain states of assets.

The system 600 can additionally include a graphical user interface 606 that displays the hierarchical representation of assets 104 as well as functionality available therewith (upon selection of a representation of at least one asset). Therefore, the graphical user interface 606 can display state-dependent functionality to a user. According to one example, verifying a particular procedure may not be available while devices utilized within the procedure are associated with certain states. Therefore, the graphical user interface 606 will not display such functionality as being available. Once the user selects a particular functionality, the management component 122 can perform the selected asset management functionality on selected assets within the industrial environment 116.

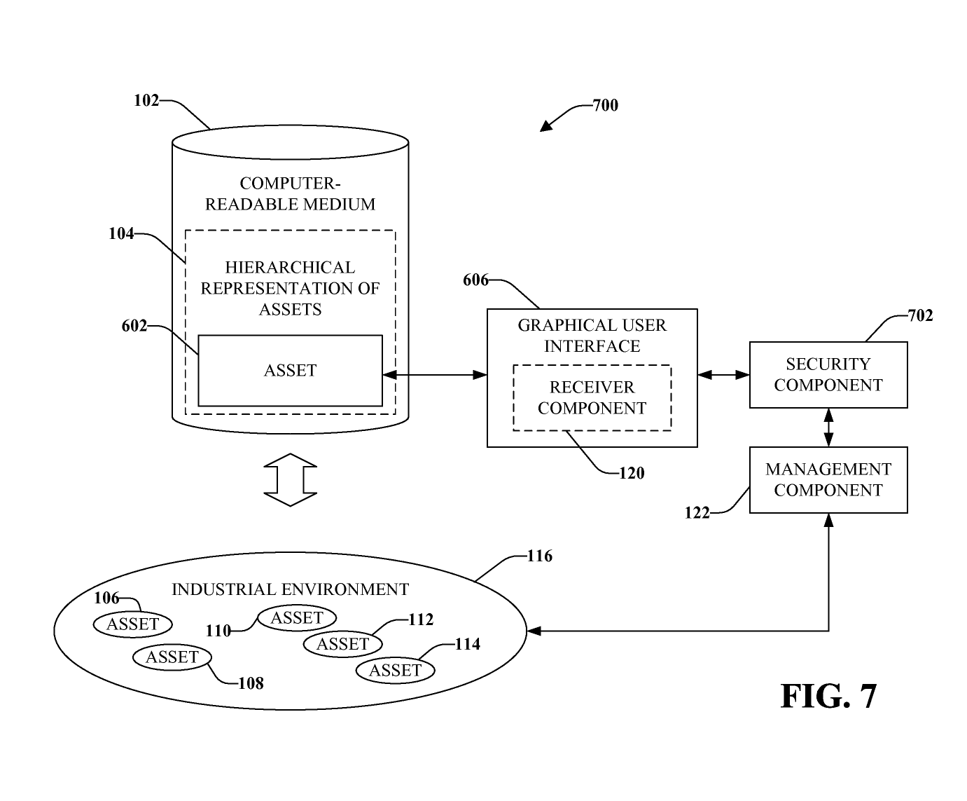

Turning now to FIG. 7, an asset management system 700 is illustrated. The system 700 includes the receiver component 120 that receives a request for an asset (or representation thereof) from a user. In one example, the receiver component 120 can be within and/or associated with the graphical user interface 606. For instance, a user can submit a request to manage an asset through use of a mouse and graphical icons displayed upon the graphical user interface 606. The system 700 additionally includes a security component 702 that can determine which assets and/or functionalities associated therewith the user is authorized to request/implement. In accordance with one example, a user may only be authorized to implement certain management functionalities with respect to a certain asset, while not authorized to implement other particular management functionalities associated with such asset. The security component 702 can determine identity of a user by analyzing, for instance, usernames, passwords, personal identification numbers, and the like. Furthermore, the security component 702 can determine a user's identity by analyzing biometric indicia, such as voice recognition, fingerprint analysis, retina analysis, etc.

Still further, the security component 702 can perform granular security with respect to a user and/or an asset. Pursuant to one example, a user's rights with respect to a particular asset can change as time alters. For instance, certain management functionality associated with an asset requested by a user can be accessible by the user during a first shift but not accessible to the user during a second shift. Additionally, the security component 702 can provide different measures of security given different states of an asset. Therefore, for example, a user may have rights with respect to functionality when an asset is in a first state but may have different rights with respect to the same functionality when the asset is in a second state. Once a user has been identified and rights associated with such user have been determined, the user can select functionality associated with an asset within the industrial environment 116. The management component 122 can thereafter be employed to implement such functionality with respect to an appropriate asset (or assets). As described above, management functionality undertaken with respect to one asset can be permeated through subordinate assets in a hierarchy.

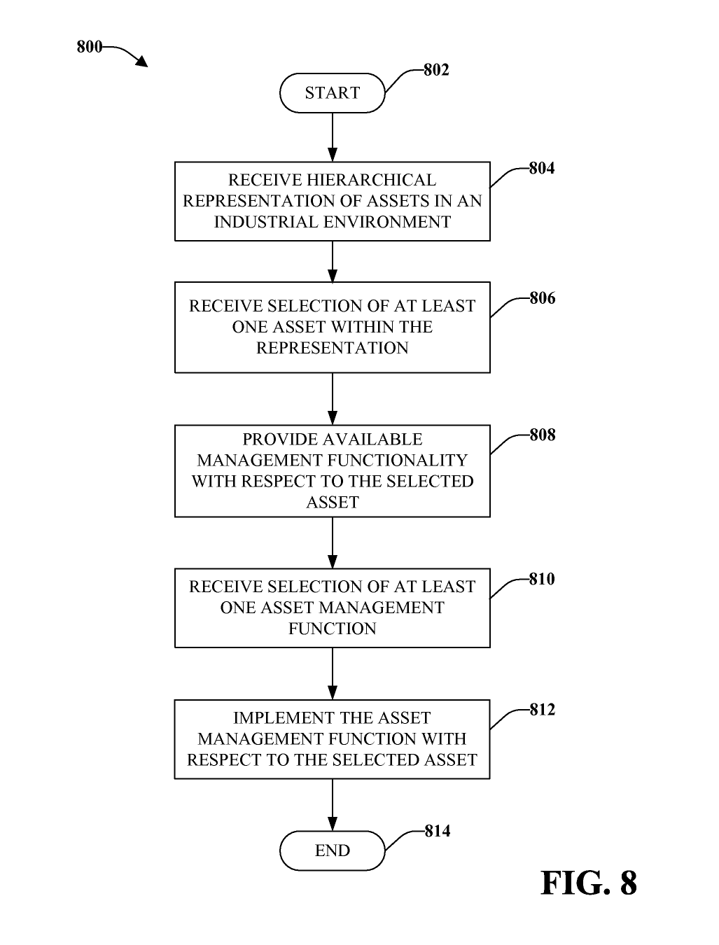

Referring to FIGS. 8-10, methodologies in accordance with various aspects of the claimed subject matter are illustrated. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Turning specifically to FIG. 8, a methodology 800 for managing one or more assets within an industrial environment. The methodology 800 starts at reference numeral 802, and at reference numeral 804 a hierarchical representation of assets in an industrial environment can be received. It is to be appreciated that an asset can be, but is not limited to, a physical device, such as a programmable logic controller, a pump, a press, and/or a portion thereof, as well as software, firmware, etc. Moreover, the hierarchical representation of assets can be, for instance, provided by a user and/or an electronic document/data. In one example, a user can evaluate an industrial environment and create the hierarchical representation by at least one of uploading data, creating an electronic document, employing a graphical user interface (GUI), and the like.

The hierarchy can be based upon location of devices (e.g., a region of a factory can have several defined sub-regions, which in turn can comprise sub-regions), standards associated with industry, such as ISA S95, ISA S88, and the like, a proprietary hierarchy that is provided by an enterprise, or any other suitable hierarchy. For example, a top portion of the hierarchy may be a plant, and a sub-level of the plant may be programmable logic controllers utilized within the plant, and a sub-level of the programmable logic controllers can be devices controlled by such controllers. It is understood and appreciated that this is but one example of a hierarchy, and the claimed subject matter is not to be so limited. Furthermore, the hierarchically representation of assets can represent a hierarchically arrangement of two or more assets within an industrial environment, such as one that is utilized to manufacture consumables, textiles, automobiles, or any other suitable industrial environment. To illustrate another example hierarchy, the asset may be a programmable logic controller, while the assets and may be different control programs effectuated by the asset. Thus, the hierarchical representation of assets may be a combination of physical devices and software.

At reference numeral 806, a selection of at least one asset within the representation can be received. For instance, the selection of the asset can be via an interface, a graphical user interface (GUI), an input device, an application programmable interface (API), a pointing and clicking mechanism, a pressure-sensitive screen, voice commands, software associated with selecting the representation of the asset, or any other suitable manner for selecting an asset. At reference numeral 808, available management functionality is provided with respect to the selected asset. For example, the user can select an asset and the respective functionality and/or functionalities can be effectuated for the particular asset within the industrial environment. At reference numeral 810, a selection of at least one asset management function can be received. For instance, the selection of the asset management function can be via an interface, a graphical user interface (GUI), an input device, an application programmable interface (API), a pointing and clicking mechanism, a pressure-sensitive screen, voice commands, software associated with selecting the representation of the asset, or any other suitable manner for selecting an asset management function. At reference numeral 812, the asset management function can be implemented with respect to the selected asset. Thus, for instance, if the representation of the asset represents a PLC, and the user selects such representation, functionality such as “back up PLC”, “archive data within the PLC”, “update PLC with particular firmware”, and the like can be provided to the user. Once the user selects desired functionality, the requested function can be automatically performed. For instance, the PLC can be backed up if the user selects the “backup PLC” functionality. The methodology 800 then completes at reference numeral 814.

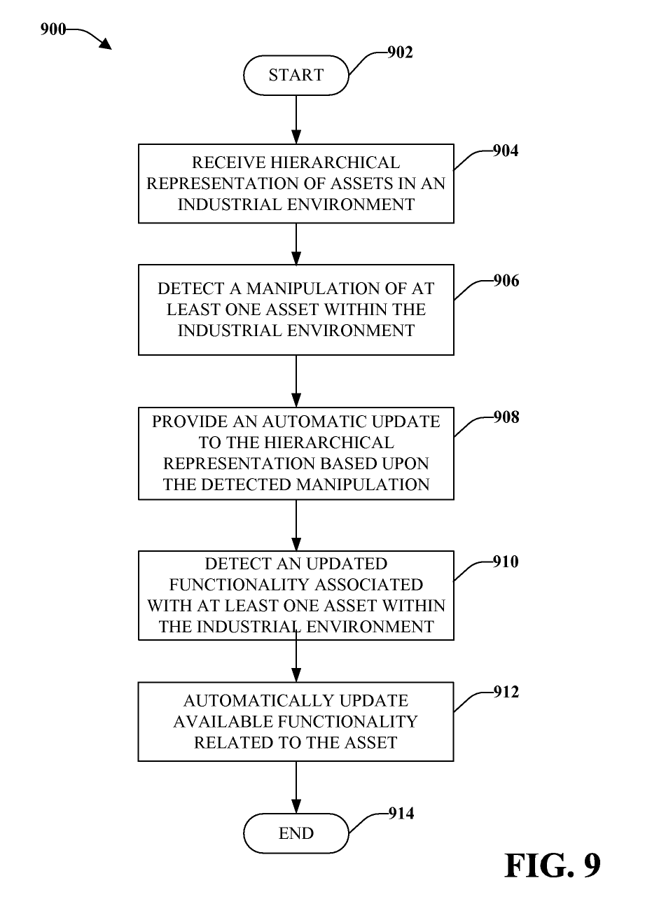

Turning now to FIG. 9, a methodology 900 for automatically updating the hierarchical representation of assets with respect to assets that are added, updated, or removed from the industrial environment. The methodology 900 starts at reference numeral 902, and at reference numeral 904 a hierarchical representation of assets in an industrial environment can be received. It is to be appreciated that the hierarchical representation can be based upon location, and various devices and software can reside in the hierarchy beneath the location. One skilled in the art will appreciate that various asset management functionalities can be permeated throughout any suitable portions of a hierarchy and/or a hierarchical representation of assets within an industrial environment. Moreover, an asset can be, for example, a physical device, such as a programmable logic controller, a pump, a press, and/or a portion thereof, as well as software, firmware, etc.

At reference numeral 906, a manipulation of at least one asset within the industrial environment can be detected. For example, assets within the industrial environment can be edited, reconfigured, relocated, added, removed, updated, and the like. Thus, once an asset has been manipulated in such a manner, such manipulation and/or change can be detected accordingly. At reference numeral 908, an automatic update to the hierarchical representation can be provided based at least in part upon the detected manipulation. In other words, the hierarchical representation of assets can be continuously updated and/or maintained in connection with the various changes that may affect an asset within the industrial environment.

At reference numeral 910, an updated functionality associated with at least one asset within the industrial environment can be detected. For example, an asset within the industrial environment can be updated to provide additional functionality, updated functionality, disparate operations, and the like. At reference numeral 912, the available functionality for an asset can be automatically updated to allow for implementation. In other words, an asset functionality can be added, automatically detected and updated to allow a user to employ such functionality on the particular asset. The methodology 900 then completes at reference numeral 914.

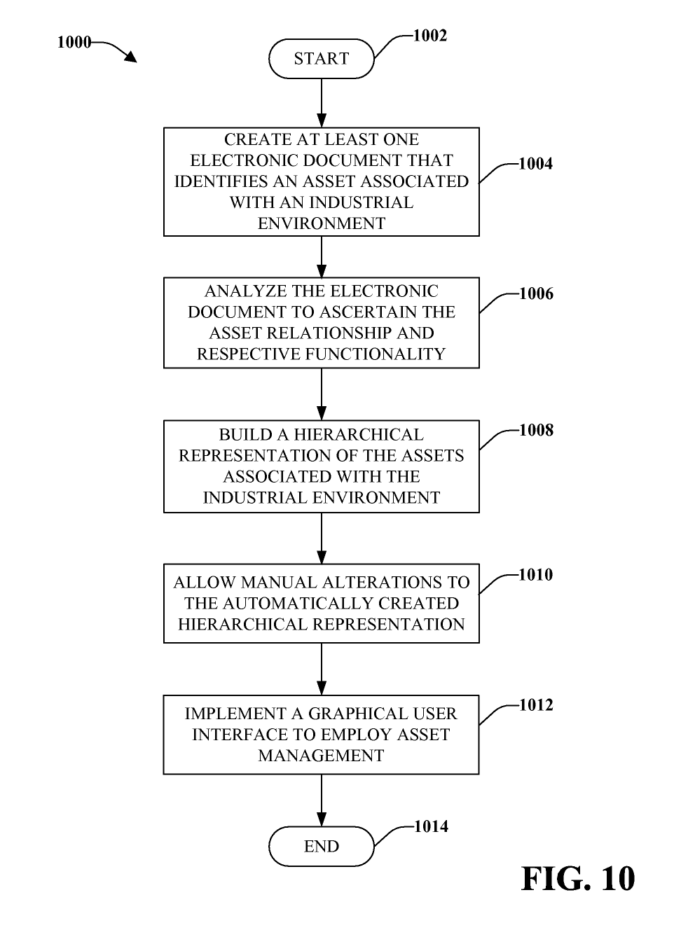

Referring now to FIG. 10, a methodology 1000 that facilitates automatically creating a hierarchical representation of assets. The methodology 1000 starts at reference numeral 1002, and at reference numeral 1004 at least one electronic document that identifies an asset associated with an industrial environment can be created. For instance, the electronic document can be associated with an asset that is employed and/or is possibly employed within the industrial environment. The electronic document may be descriptive of operation of assets, such as operation instructions. The electronic document can also be a warranty or any other suitable documents relating to assets within the industrial environment. At reference numeral 1006, the electronic document can be analyzed to ascertain the asset relationship and respective functionality. In other words, the electronic document can provide any suitable information related to the particular asset such as, but not limited to, available asset management functionality and/or operations, location and/or relationship within a hierarchical representation of at least a portion of the totality of assets within an industrial environment, etc.

At reference numeral 1008, a hierarchical representation f the assets associated with the industrial environment can be built and/or created. For instance, based on a plurality of assets within a particular industrial environment, wherein at least one electronic document relates to the assets, a hierarchical representation of the assets can be created based upon data included within the electronic document(s). At reference numeral 1010, manual alterations to the automatically created hierarchical representation can be employed. For instance, upon automatic creation of the hierarchical representation of assets, a user may desire to implement manual alterations and/or changes accordingly. At reference numeral 1012, a graphical user interface (GUI) can be implemented to facilitate employing asset management in connection with the industrial environment. In one example, the graphical user interface can display the hierarchical representation of assets as well as functionality available therewith (upon selection of a representation of at least one asset). Therefore, the graphical user interface can display state-dependent functionality to a user. The methodology 1000 then completes at reference numeral 1014.

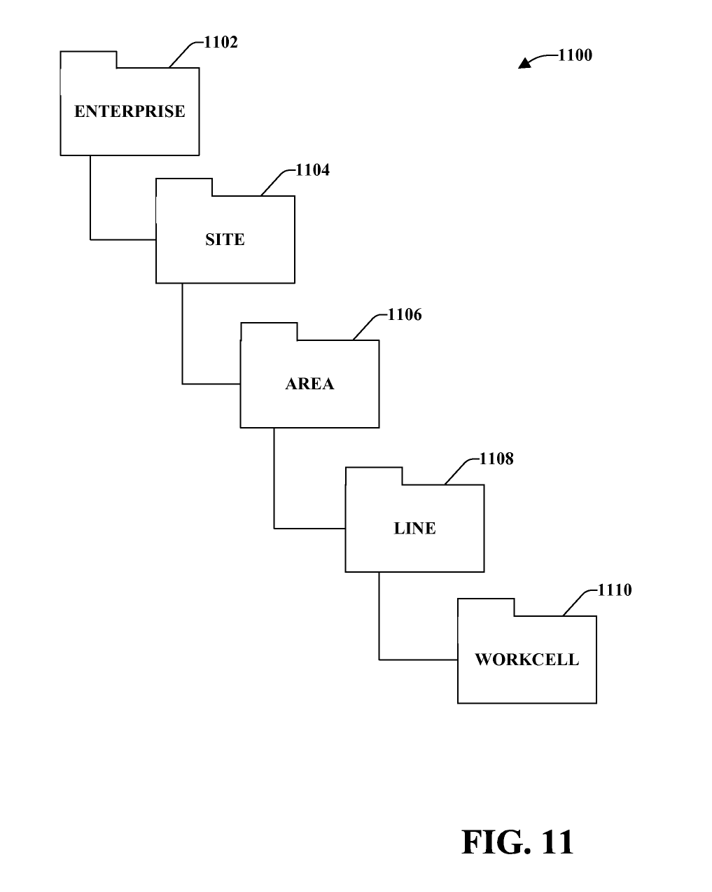

Referring now to FIG. 11, an exemplary hierarchical structure 1100 which can be utilized in connection with the hierarchically structured data model (e.g., hierarchical representation of assets) alluded to herein is illustrated. For example, the data model can facilitate nested structures, thereby mitigating deficiencies associated with data models that employ flat namespaces. The structure 1100 includes an enterprise level 1102, where a particular enterprise can be represented within data structured in accordance with a hierarchical data model. Beneath the enterprise level 1102 can be a site level 1104, so that a particular factory (site) within an enterprise can be represented within a data packet. Beneath the site level 1104 an area level 1106 can exist, which specifies an area within the factory that relates to the data. A line level 1108 can lie beneath the area level 1106, wherein the line level 1108 is indicative of a line associated with particular data. Beneath the line level 1108 a workcell level 1110 can exist, thereby indicating a workcell associated with the data. Utilizing a nested, hierarchical data model, PLCs can become more aware of data associated therewith. Furthermore, the hierarchy 1100 can be customized by an owner of such hierarchy. For instance, more granular objects/levels can be defined within the hierarchy 1100 in relation to the various assets associated therewith.

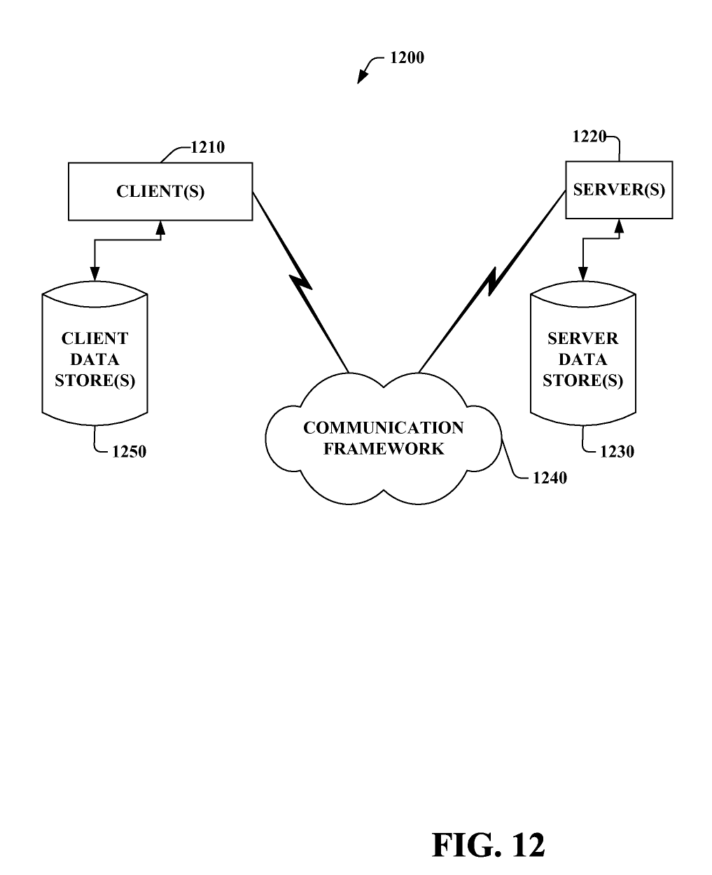

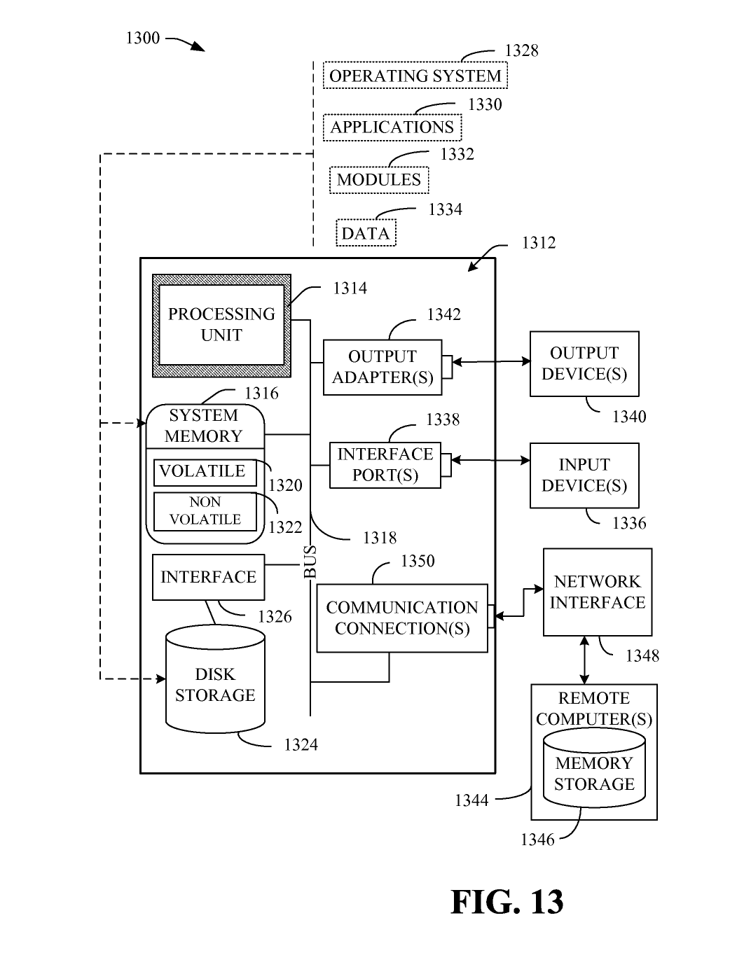

In order to provide additional context for implementing various aspects of the claimed subject matter, FIGS. 12-13 and the following discussion is intended to provide a brief, general description of a suitable computing environment in which the various aspects of the subject innovation may be implemented. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 12 is a schematic block diagram of a sample-computing environment 1200 with which the claimed subject matter can interact. The system 1200 includes one or more client(s) 1210. The client(s) 1210 can be hardware and/or software (e.g., threads, processes, computing devices). The system 1200 also includes one or more server(s) 1220. The server(s) 1220 can be hardware and/or software (e.g., threads, processes, computing devices). The servers 1220 can house threads to perform transformations by employing the subject innovation, for example.

One possible communication between a client 1210 and a server 1220 can be in the form of a data packet adapted to be transmitted between two or more computer processes. The system 1200 includes a communication framework 1240 that can be employed to facilitate communications between the client(s) 1210 and the server(s) 1220. The client(s) 1210 are operably connected to one or more client data store(s) 1250 that can be employed to store information local to the client(s) 1210. Similarly, the server(s) 1220 are operably connected to one or more server data store(s) 1230 that can be employed to store information local to the servers 1220.

With reference to FIG. 13, an exemplary environment 1300 for implementing various aspects of the claimed subject matter includes a computer 1312. The computer 1312 includes a processing unit 1314, a system memory 1316, and a system bus 1318. The system bus 1318 couples system components including, but not limited to, the system memory 1316 to the processing unit 1314. The processing unit 1314 can be any of various available processors. Dual microprocessors and other multiprocessor architectures also can be employed as the processing unit 1314.

The system bus 1318 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1316 includes volatile memory 1320 and nonvolatile memory 1322. The basic input/output system (BIOS), containing the basic routines to transfer information between elements within the computer 1312, such as during start-up, is stored in nonvolatile memory 1322. By way of illustration, and not limitation, nonvolatile memory 1322 can include read only memory (ROM), programmable ROM (PROM), electrically programmable ROM (EPROM), electrically erasable programmable ROM (EEPROM), or flash memory. Volatile memory 1320 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1312 also includes removable/non-removable, volatile/non-volatile computer storage media. FIG. 13 illustrates, for example a disk storage 1324. Disk storage 1324 includes, but is not limited to, devices like a magnetic disk drive, floppy disk drive, tape drive, Jaz drive, Zip drive, LS-100 drive, flash memory card, or memory stick. In addition, disk storage 1324 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1324 to the system bus 1318, a removable or non-removable interface is typically used such as interface 1326.

It is to be appreciated that FIG. 13 describes software that acts as an intermediary between users and the basic computer resources described in the suitable operating environment 1300. Such software includes an operating system 1328. Operating system 1328, which can be stored on disk storage 1324, acts to control and allocate resources of the computer system 1312. System applications 1330 take advantage of the management of resources by operating system 1328 through program modules 1332 and program data 1334 stored either in system memory 1316 or on disk storage 1324. It is to be appreciated that the claimed subject matter can be implemented with various operating systems or combinations of operating systems.

A user enters commands or information into the computer 1312 through input device(s) 1336. Input devices 1336 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1314 through the system bus 1318 via interface port(s) 1338. Interface port(s) 1338 include, for example, a serial port, a parallel port, a game port, and a universal serial bus (USB). Output device(s) 1340 use some of the same type of ports as input device(s) 1336. Thus, for example, a USB port may be used to provide input to computer 1312, and to output information from computer 1312 to an output device 1340. Output adapter 1342 is provided to illustrate that there are some output devices 1340 like monitors, speakers, and printers, among other output devices 1340, which require special adapters. The output adapters 1342 include, by way of illustration and not limitation, video and sound cards that provide a means of connection between the output device 1340 and the system bus 1318. It should be noted that other devices and/or systems of devices provide both input and output capabilities such as remote computer(s) 1344.

Computer 1312 can operate in a networked environment using logical connections to one or more remote computers, such as remote computer(s) 1344. The remote computer(s) 1344 can be a personal computer, a server, a router, a network PC, a workstation, a microprocessor based appliance, a peer device or other common network node and the like, and typically includes many or all of the elements described relative to computer 1312. For purposes of brevity, only a memory storage device 1346 is illustrated with remote computer(s) 1344. Remote computer(s) 1344 is logically connected to computer 1312 through a network interface 1348 and then physically connected via communication connection 1350. Network interface 1348 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1350 refers to the hardware/software employed to connect the network interface 1348 to the bus 1318. While communication connection 1350 is shown for illustrative clarity inside computer 1312, it can also be external to computer 1312. The hardware/software necessary for connection to the network interface 1348 includes, for exemplary purposes only, internal and external technologies such as, modems including regular telephone grade modems, cable modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that facilitates asset management, comprising:
a data repository that retains a hierarchical representation of at least one asset persisted within a computer-readable medium, the at least one asset is associated with an industrial environment;
a receiver component that receives an input related to a selection of at least one asset and a respective asset management functionality; and
a management component that automatically effectuates the requested asset management functionality with respect to the asset.

2. The system of claim 1, the asset is at least one of a physical device, software, and a firmware.

3. The system of claim 1, the physical device is at least one of a programmable logic controller, a pump, a press, a valve, a drain, a heater, a cooler, a switch, a sensor, and a conveyor.

4. The system of claim 1, the asset management functionality relates to at least one of validating an asset, backing up an asset, archiving data associated with an asset, updating an asset with new software, updating an asset with new firmware, updating an asset with additional software, and updating an asset with additional firmware.

5. The system of claim 1, the receiver component is at least one of an input device, a touch-screen, a microphone that receives a voice command, and software associated with selecting the representation of the asset.

6. The system of claim 1, the hierarchical representation of assets is based at least in part upon a physical location of the asset within the industrial environment.

7. The system of claim 1, the hierarchical representation of assets is based at least in part upon an industry standard which can be at least one of ISA S95, ISA S88, and a combination thereof.

8. The system of claim 1, the hierarchical representation of assets is based at least in part upon a proprietary hierarchy that is provided by an enterprise.

9. The system of claim 1, the hierarchical representation of assets allows the asset management functionality to permeate through lower levels of the hierarchy.

10. The system of claim 1, further comprising a detection component that ascertains at least one of when an asset has been added to the industrial environment, when an asset has been removed from the industrial environment, and when an asset has been updated within the industrial environment.

11. The system of claim 10, the asset includes sufficient intelligence to initiate a message to the detection component, wherein such message can include at least one of a type of the asset, an identity of the asset, a location upon a network of the asset, and an associated asset.

12. The system of claim 11, the asset utilizes an identification data to detect and maintain alterations of an asset within the industrial environment.

13. The system of claim 10, further comprising an updating component that updates the hierarchical representation of assets within the data repository based upon an alteration determined by the detection component.

14. The system of claim 1, the data repository includes at least one electronic document that is associated with an asset employed within the industrial environment.

15. The system of claim 14, the electronic document is descriptive of at least at one of an operation of assets, an asset management functionality, an asset description, an asset location within an industrial environment, an asset location within a hierarchical layout of an industrial environment, descriptive of an operation of an asset, an instruction, a warranty, and an operation instruction.

16. The system of claim 14, further comprising an analysis component that ascertains the content of at least one electronic document to determine at least one of a type of asset and a relationship between two or more assets.

17. The system of claim 16, further comprising a building component that automatically creates a hierarchical representation of assets based at least in part upon the analysis component.

18. The system of claim 1, further comprising a stimulating component that provides the asset with an electrical stimuli.

19. The system of claim 18, the stimulating component is an electrical power source which provides an electrical pulse to the asset to ascertain identification data related to the asset.

20. The system of claim 19, further comprising a recognition component that identifies the asset based on the electrical power source.

21. The system of claim 19, the identification data is a fingerprint.

22. The system of claim 1, further comprising a security component that ascertains authorization related to at least one of an asset to request and a functionality to employ.

23. The system of claim 1, further comprising a graphical user interface that includes a first field that provides a user with a hierarchical representation of assets within an industrial environment and a second field that displays available management functionality associated with an asset selected within the first field.

24. A method that facilitates asset management within an industrial environment, comprising:
receiving a hierarchical representation of an asset in the industrial environment;
receiving a selection of at least one asset within the representation;
providing an available management functionality with respect to the selected asset;
receiving a selection of at least one asset management function; and
implementing the asset management function with respect to the selected asset.

25. The method of claim 24, the hierarchical manner is based at least in part upon a physical location of the asset within the industrial environment.

26. The method of claim 24, the hierarchical manner is based at least in part upon an industry standard which can be at least one of ISA S95, ISA S88, and a combination thereof.

27. The method of claim 24, the hierarchical manner is based at least in part upon a proprietary hierarchy that is provided by an enterprise.

28. The method of claim 24, the asset is at least one of a physical device, software, and firmware.

29. The method of claim 24, the physical device is at least one of a programmable logic controller, a pump, a press, a valve, a drain, a heater, a cooler, a switch, a sensor, and a conveyor.

30. The method of claim 24, the management functionality relates to at least one of validating an asset, backing up an asset, archiving data associated with an asset, updating an asset with new software, updating an asset with new firmware, updating an asset with additional software, and updating an asset with additional firmware.

31. The method of claim 24, further comprising:
detecting a manipulation of at least one asset within the industrial environment; and
providing an automatic update to the hierarchical representation based upon the detected manipulation.

32. The method of claim 24, further comprising:
detecting an updated functionality associated with at least one asset within the industrial environment; and
automatically updating the available functionality related to the asset.

33. The method of claim 24, further comprising:
creating at least one electronic document that identifies an asset within an industrial environment;
analyzing the electronic document to ascertain at least one of an asset relationship and an asset management functionality;
building a hierarchical representation of the assets associated with the industrial environment;
allowing a manual alteration to the automatically created hierarchical representation; and
implementing a graphical user interface to employ an asset management functionality.

34. A computer-implemented system that facilitates asset management, comprising:
means for representing at least one asset from an industrial environment in a hierarchical representation;
means for receiving an input related to a selection of at least one asset and a respective asset management functionality; and
means for automatically employing the requested asset management functionality with respect to the asset within the industrial environment.
